(19) United States
(12) Patent Application Publication
(10) Pub. No.: US 2026/0321217 A1
(43) Pub. Date: Oct. 15, 2026

(54) BACKLIGHT UNIT CONTROL METHOD, AND DEVICE

(71) Applicant: Beijing Xianxin Technology Co., Ltd, BDA Beijing (CN)

(72) Inventors: Kiwon LEE, BDA Beijing (CN); Youngjin LIM, BDA Beijing (CN); Chenghui YAN, BDA Beijing (CN)

(73) Assignee: Beijing Xianxin Technology Co., Ltd, BDA Beijing (CN)

(21) Appl. No.: 19/698,348

(22) Filed: Jun. 4, 2026

Related U.S. Application Data
(63) Continuation of application No. PCT/CN2024/136774, filed on Dec. 4, 2024.

(30) Foreign Application Priority Data
Dec. 11, 2023 (CN) 202311697032.7

(51) Int. Cl. G09G 3/34

(52) U.S. Cl. CPC G09G 3/3426; G09G 2310/08; G09G 2320/103

(57) ABSTRACT

A backlight unit control method, and device, including: acquiring a driving sequence of each pixel of a display panel, and determining a driving sequence of each backlight area of a backlight unit based on the driving sequence of each pixel of the display panel; acquiring image data, generating local dimming data of each backlight area according to the image data, and driving a driving unit of each backlight area based on the local dimming data of the backlight area and the driving sequence of each backlight area. In this way, the synchronous display of the backlight unit and the display panel is realized.

### CROSS-REFERENCE TO RELATED APPLICATIONS

The present application is a continuation of International Application No. PCT/CN2024/136774, filed on Dec. 4, 2024, which claims priority to Chinese Patent Application No. 202311697032.7 filed on Dec. 11, 2023, both of which are hereby incorporated by reference in their entireties.

### TECHNICAL FIELD

The present application relates to, but is not limited to, a backlight unit control method, and device.

### BACKGROUND

With the development of technology, display devices have become an important component of many electronic devices. A display device usually consists of a display panel and a backlight unit. The backlight unit is configured to provide a backlight source for a display panel.

How to improve the performance of display devices has always been a hot research topic.

### SUMMARY

The present application provides a backlight unit control method, including:
acquiring a driving sequence of each pixel of a display panel, and determining a driving sequence of each backlight area of a backlight unit according to the driving sequence of each pixel of the display panel;
acquiring image data, generating local dimming data of each backlight area based on the image data, and driving a driving unit of each backlight area based on the local dimming data of the backlight area and the driving sequence of each backlight area.

In some embodiments, determining the driving sequence of each backlight area of the backlight unit according to the driving sequence of each pixel of the display panel specifically includes:
determining a backlight area corresponding to each pixel, and taking the driving sequence of each pixel of the display panel as a driving sequence of the backlight area corresponding to each pixel.

In some embodiments, taking the driving sequence of each pixel of the display panel as the driving sequence of the backlight area corresponding to each pixel specifically includes:
determining that the driving sequence of the backlight area corresponding to each pixel is driving at least one row of backlight areas each time, when the driving sequence of each pixel of the display panel is driving at least one row of pixels each time.

In some embodiments, pixels arranged along a first direction are connected to a gate driver chip through a scan line, pixels arranged along a second direction are connected to a source driver chip through a data line, the gate driver chip is configured to send a scanning signal to at least one scan line to allow at least one row of pixels to receive the scanning signal, and the source driver chip sends data to all data lines to allow all columns of pixels to receive the data.

In some embodiments, acquiring image data of a current pixel, generating local dimming data of each backlight area based on the image data, and driving the driving unit of each backlight area based on the local dimming data of the backlight area and the driving sequence of each backlight area specifically includes:
acquiring image data of a current pixel, generating local dimming data of a current backlight area based on the image data of the current pixel, and sending the local dimming data to a current driving unit;
where the current backlight area corresponds to an area where the current pixel is located, and the current driving unit is a driving unit corresponding to the current backlight area.

In some embodiments, sending the local dimming data to the current driving unit specifically includes:
generating a dimming data packet of the current driving unit based on the local dimming data of the current backlight area and an address of the driving unit corresponding to the current backlight area, and sending the local dimming data packet to the current driving unit.

In some embodiments, generating the dimming data packet of the current driving unit based on the local dimming data of the current backlight area and the address of the driving unit corresponding to the current backlight area specifically includes:
generating the dimming data packet based on the local dimming data, a preset delay time and the address of the driving unit, and sending the dimming data packet to the current driving unit to allow the current driving unit to delay lighting up the backlight area based on the preset delay time after receiving the dimming data packet.

In some embodiments, sending the local dimming data packet to the current driving unit specifically includes:
sending the dimming data packet to the driving unit after waiting for the preset delay time.

Some embodiments of the present application provide a backlight unit control device, including:
an acquiring module, configured to acquire a driving sequence of each pixel of a display panel, and determine a driving sequence of each backlight area of a backlight unit according to the driving sequence of each pixel of the display panel;
a processing module, configured to acquire image data, generate local dimming data of each backlight area based on the image data, and drive a driving unit of each backlight area based on the local dimming data of the backlight area and the driving sequence of each backlight area.

Some embodiments of the present application provide a controller, including: a processor, and a memory communicatively connected to the processor; where
the memory stores computer-executable instructions;
the processor executes the computer-executable instructions stored in the memory to implement the method according to the foregoing embodiments.

Some embodiments of the present application provide a computer-readable storage medium, where computer-executable instructions are stored in the computer-readable storage medium, and the computer-executable instructions, when executed by a processor, are configured to implement the method according to the foregoing embodiments.

According to the backlight unit control method and device provided by the present application, a driving sequence of each pixel of a display panel is acquired, and a driving sequence of each backlight area of a backlight unit is determined according to the driving sequence of each pixel of the display panel. Then, a driving unit of each backlight area is driven based on local dimming data of the backlight area and the driving sequence of each backlight area, such that each backlight area emits light in accordance with the driving sequence of each backlight area. In this way, the synchronous display of the backlight unit and the display panel is realized.

### BRIEF DESCRIPTION OF DRAWINGS

The accompanying drawings, which are incorporated in and constitute a part of this specification, illustrate embodiments consistent with the present application and, together with the description, serve to explain the principle of the present application.

FIG. 1 is a schematic diagram of a direct-lit backlight display device without using a local dimming technology.

FIG. 2 is a schematic diagram of a direct-lit backlight display device using a local dimming technology.

FIG. 3 is a schematic diagram of a display device adopting a direct-lit backlight, integrating local dimming technology and using an AM driving mode.

FIG. 4 is a schematic flow diagram of a backlight unit control method according to some embodiments of the present application.

FIG. 5 is a schematic structural diagram of a display device according to some embodiments of the present application.

FIG. 6 is a schematic structural diagram of a backlight unit according to some embodiments of the present application.

FIG. 7 is a schematic diagram of a lighting sequence of the backlight unit shown in FIG. 6.

FIG. 8 is a schematic diagram of another lighting sequence of the backlight unit shown in FIG. 6.

FIG. 9 is a schematic structural diagram of a backlight unit according to other embodiments of the present application.

FIG. 10 is a schematic diagram of a lighting sequence of the backlight unit shown in FIG. 9.

FIG. 11 is a schematic structural diagram of a backlight unit according to other embodiments of the present application.

FIG. 12 is a schematic diagram of a lighting sequence of the backlight unit shown in FIG. 11.

FIG. 13 is a schematic diagram of a controller according to some embodiments of the present application.

### EXPLANATION OF REFERENCE SIGNS

100—backlight unit; 200—display panel; 10—driving unit; 30—backlight area; 40—pixel; 300—dimming controller; 400—timing controller; 210—gate driver chip; 220—source driver chip; X-first direction; Y-second direction.

The above drawings have shown specific embodiments of the present application, which are described in more detail hereinafter. These drawings and text description are not intended to limit the scope of the inventive concept of the present application in any way, but to illustrate the concept of the present application to those skilled in the art with reference to specific embodiments.

### DESCRIPTION OF EMBODIMENTS

Exemplary embodiments are described in detail herein, with examples illustrated in the accompanying drawings. When the following description refers to the accompanying drawings, the same numerals in different drawings denote the same or similar elements unless otherwise indicated. The implementations described in the following exemplary embodiments do not represent all implementations consistent with the present application. On the contrary, they are merely examples of devices and methods consistent with some aspects of the present application.

It should be noted that user information (including but not limited to user device information, user personal information, etc.) and data (including but not limited to data for analysis, stored data, displayed data, etc.) involved in the present application are information and data authorized by the user or fully authorized by all parties, and the collection, use and processing of relevant data comply with relevant laws, regulations and standards of relevant countries and regions, and corresponding operation entrances are provided for users to choose authorization or refusal.

Backlight modes of display devices include direct-lit backlight and edge-lit backlight. Edge-lit backlight means that a backlight source is located on a side of a display panel, and transmits light to a screen center through a light guide plate. Direct-lit backlight means that the backlight source is located on a back of the display panel.

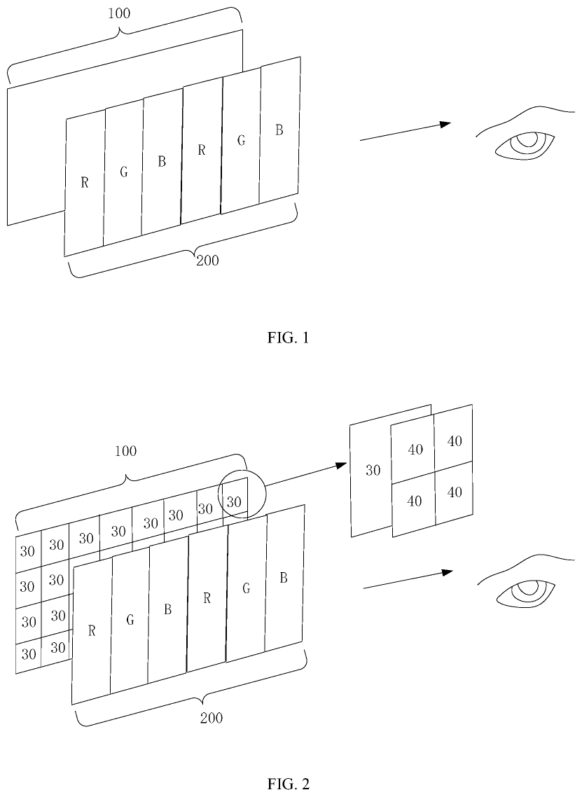

FIG. 1 is a schematic diagram of a direct-lit backlight display device without using local dimming technology. As shown in FIG. 1, a display device has a single backlight unit 100, which turns on or off simultaneously when the display device is in operation, resulting in a large driving current. FIG. 2 is a schematic diagram of a direct-lit backlight display device using local dimming technology. As shown in FIG. 2, in order to reduce the power loss of a backlight source board, mini light-emitting diode (Mini Light-emitting Diode, abbreviated as Mini-LED) technology is introduced. As a backlight source, Mini-LED may realize regional dimming, also known as local dimming (Local Dimming) technology, and the on/off of the backlight source of each backlight area 30 may be individually controlled. One backlight area 30 may be composed of at least one Mini-LED. In addition, one backlight area 30 corresponds to an area where n×m pixels 40 in a display panel 200 are located. For example, in FIG. 2, one backlight area 30 corresponds to an area where 2×2 liquid crystal pixels 40 are located. For ease of description, Mini-LED is hereinafter abbreviated as LED.

There are two main driving modes for light-emitting diodes as backlight sources: passive matrix (Passive Matrix, abbreviated as PM) driving mode and active matrix (Active Matrix, abbreviated as AM) driving mode.

In the PM driving mode, an anode of each column of LED in an LED array is connected to a column scan line, and at the same time, a cathode of each row of LED is connected to a row scan line. When a specific b-th column scanning line and a-th row scanning line are selected, the LED at their intersection (a, b) is illuminated. The entire screen performs high-speed dot-by-dot scanning in this way to achieve image display.

In the AM driving mode, a plurality of driving units (Dimmers) are provided. One driving unit may control the LEDs in a plurality of backlight areas 30, or may control the LED in one backlight area 30. One backlight area 30 may contain a plurality of LEDs, or may have only one LED; which is not limited here. A driving unit is provided for each LED, and the LED is controlled by each driving unit controls to emit light.

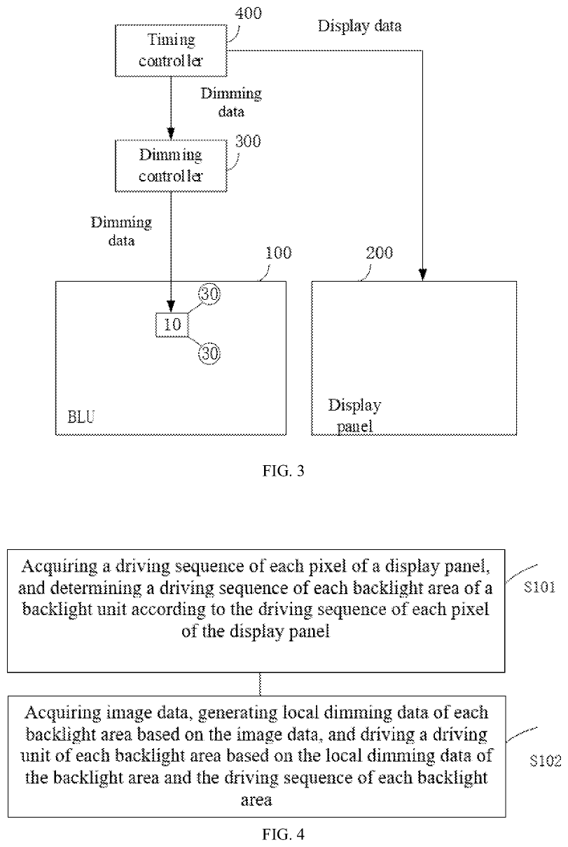

FIG. 3 is a schematic diagram of a display device adopting a direct-lit backlight and using an AM driving mode. As shown in FIG. 3, the display device includes a timing controller (Timing Controller, abbreviated as TCON), a dimming controller 300, a backlight unit 100 (Back Light Unit, abbreviated as BLU) and a display panel 200. The timing controller 400 is configured to generate display data (Display Data) and local dimming data (Local Dimming Data) according to video data, and the display data is configured to drive the display panel 200 to operate. The timing controller 400 is further configured to generate local dimming data for the entire backlight unit 100 according to the video data. The dimming controller 300 is configured to generate local dimming data of each backlight area 30 according to the local dimming data of the entire backlight unit 100, and send the local dimming data of each backlight area 30 to the driving unit of each LED. The driving unit of each LED provides a backlight driving signal to the LED, and the backlight driving signal may control a light emission brightness of the LED, thereby providing backlight with different brightness.

It should be noted herein that the function of the timing controller 400 and the dimming controller 300 may be adaptively adjusted. For example, the timing controller 400 may send image data to the dimming controller 300, and the dimming controller 300 calculates the local dimming data through a built-in dimming algorithm. The dimming controller 300 may also be omitted, and the timing controller 400 sends the local dimming data to the driving unit. That is, an architecture of the display device is not limited to the architecture shown in FIG. 3, which is merely an exemplary architecture of the display device.

Since the local dimming technology is adopted in the display device, it is required to consider synchronous display between the backlight unit 100 and the display panel 200 to improve the performance of the display device.

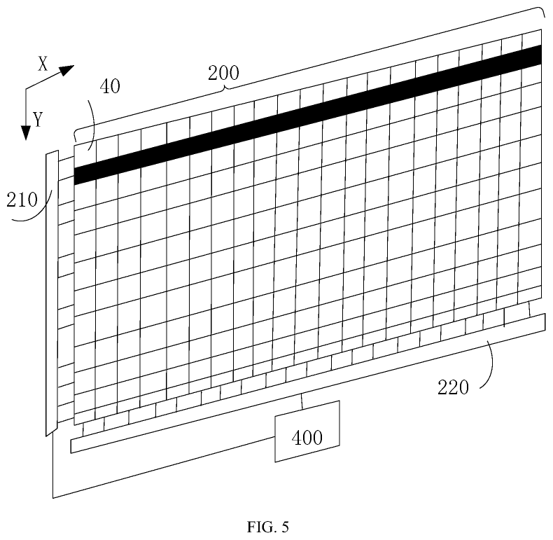

FIG. 4 is a schematic flow diagram of a backlight unit control method according to some embodiments of the present application. As shown in FIG. 4, some embodiments of the present application provide a control method of backlight unit 100, which is applied to a controller. The controller may be the timing controller in FIG. 3, the dimming controller in FIG. 3, or other controllers, which is not limited herein. The control method of backlight unit 100 specifically includes the following steps.
S101: acquiring a driving sequence of each pixel of a display panel, and determining a driving sequence of each backlight area of a backlight unit based on the driving sequence of each pixel of the display panel.

Where, as shown in FIG. 5, the display panel 200 includes a plurality of pixels 40. The plurality of pixels 40 are arranged at intervals along a first direction X, and are also arranged at intervals along a second direction Y. A driving sequence of each pixel of the display panel may be determined based on video data to be displayed or image data to be displayed, or may be determined based on configuration parameters of the display panel, which is not limited herein.

The driving sequence of each pixel of the display panel is taken as a driving sequence of each backlight area of the backlight unit. More specifically, a backlight area corresponding to each pixel is determined, and the driving sequence of each pixel of the display panel is taken as a driving sequence of the backlight area corresponding to each pixel.

As shown in FIG. 5, the display device further includes a source driver chip 220 and a gate driver chip 210. The pixels of the display panel include a thin film transistor (Thin Film Transistor, abbreviated as TFT). The source driver chip 220 is configured to drive a source of the thin film transistor in the display panel, and the gate driver chip 210 is configured to drive a gate of the TFT in the display panel. The timing controller 400 sends data to the source driver chip 220, and the timing controller sends a scanning signal to the gate driver chip 210, so as to drive the thin film transistor in the display panel to emit light according to the received data.

In some embodiments, pixels arranged along the first direction X are connected to the gate driver chip through a scan line, and pixels arranged along the second direction Y are connected to the source driver chip through a data line. The gate driver chip is configured to send a scanning signal to at least one scan line to allow at least one row of pixels to receive the scanning signal; and the source driver chip sends data to all data lines to allow all columns of pixels to receive the data, thereby realizing driving at least one row of pixels to display by the timing controller, the gate driver chip and the source driver chip.

In some embodiments, the driving sequence of the backlight area corresponding to each pixel is determined to be driving at least one row of backlight areas each time, when the driving sequence of each pixel of the display panel is driving at least one row of pixels each time. That is, the driving sequence of each pixel of the display panel is driving in a unit of pixel row.

In some embodiments, the number of pixel row driven each time may be one or more, which is not limited herein. The number of pixel row driven each time may be the same or different, which is not limited herein. A driving sequence of each pixel of the display panel may be from one end of the display panel along the second direction Y to the other end of the display panel along the second direction Y, or may be from a middle of the display panel to two ends of the display panel, which is not limited herein.

In some embodiments, in one frame of image, the number of pixel row driven each time is the same, one row of pixels being driven each time, and a driving sequence of each pixel of the display panel is from one end of the display panel along the second direction Y to the other end of the display panel along the second direction Y.

For example, a driving sequence of each pixel of the display panel is as follows: the first row of pixels, the second row of pixels, . . . , the penultimate row of pixels, and the last row of pixels. A driving sequence of each backlight area is as follows: a backlight area corresponding to the first row of pixels, a backlight area corresponding to the second row of pixels, . . . , a backlight area corresponding to the penultimate row of pixels, and a backlight area corresponding to the last row of pixels.

In some embodiments, in one frame of image, the number of pixel row driven each time is the same, one row of pixels being driven each time, and a driving sequence of each pixel of the display panel is from a middle row of pixels of the display panel to pixels at one end of the display panel along the second direction Y, and then from the middle row of pixels of the display panel to pixels at the other end of the display panel along the second direction Y.

For example, a driving sequence of each pixel of the display panel is as follows: the N-th row of pixels, the (N−1)-th row of pixels, . . . , the first row of pixels, the (N+1)-th row of pixels, the (N+2)-th row of pixels, . . . , the 2N-th row of pixels.

In some embodiments, in one frame of image, the number of pixel row driven each time is the same, and a plurality of rows of pixels are driven each time. A driving sequence of each pixel of the display panel is from one end of the display panel along the second direction Y to the other end of the display panel along the second direction Y.

For example, a driving sequence of each pixel of the display panel is first driving the first row of pixels and the second row of pixels, then driving the third row of pixels and the fourth row of pixels, . . . . A driving sequence of each backlight area is as follows: the backlight area corresponding to the first row of pixels and the second row of pixels, the backlight area corresponding to the third row of pixels and the fourth row of pixels, . . . .

In some embodiments, in one frame of image, the number of pixel row driven each time is the same, and a plurality of rows of pixels are driven each time; and a driving sequence of each pixel of the display panel is from a middle row of pixels of the display panel to pixels at one end of the display panel along the second direction Y, and then from the middle row of pixels of the display panel to pixels at the other end of the display panel along the second direction Y.

For example, a driving sequence of each pixel of the display panel is first driving the N-th row of pixels and the (N−1)-th row of pixels, then driving the (N−2)-th row of pixels and the (N−3)-th row of pixels, . . . , the second row of pixels and the first row of pixels, the (N+1)-th row of pixels and the (N+2)-th row of pixels, the (N+3)-th row of pixels and the (N+4)-th row of pixels, . . . , the (2N−1)-th row of pixels and the 2N-th row of pixels.

In some embodiments, the number of pixel row driven each time in one frame of image is different. A driving sequence of each pixel of the display panel is from one end of the display panel along the second direction Y to the other end of the display panel along the second direction Y.

For example, a driving sequence of each pixel of the display panel is first driving the first row of pixels, then driving the second row of pixels and the third row of pixels, then driving the fourth row of pixels, the fifth row of pixels and the sixth row of pixels, . . . . A driving sequence of each backlight area is as follows: the backlight area corresponding to the first row of pixels, the backlight area corresponding to the second row of pixels and the third row of pixels, the backlight area corresponding to the fourth row of pixels, the fifth row of pixels and the sixth row of pixels, . . . .

In some embodiments, the number of pixel row driven each time in one frame of image is different, and a driving sequence of each pixel of the display panel is from a middle row of pixels of the display panel to pixels at one end of the display panel along the second direction Y, and then from the middle row of pixels of the display panel to pixels at the other end of the display panel along the second direction Y.
S102: acquiring image data, generating local dimming data of each backlight area based on the image data, and driving a driving unit of each backlight area based on the local dimming data of the backlight area and the driving sequence of each backlight area.

Where, the existing dimming algorithm is used to process the image data to generate the local dimming data of each backlight area. The local dimming data of the backlight area is sent to the driving unit of each backlight area, and each driving unit is driven according to the driving sequence of each backlight area, so that each backlight area emits light according to the driving sequence of each backlight area. In this way, the synchronous display of the backlight unit and the display panel is realized.

In the above technical solutions, a driving sequence of each pixel of a display panel is acquired, and a driving sequence of each backlight area of a backlight unit is determined based on the driving sequence of each pixel of the display panel; then, based on local dimming data of the backlight area, a driving unit of each backlight area is driven according to the driving sequence of each backlight area, such that each backlight area emits light in accordance with the driving sequence of each backlight area. In this way, the synchronous display between the backlight unit and the display panel is realized.

Some embodiments of the present application provide a backlight unit control method, which is applied to a controller. The backlight unit control method specifically includes the following steps.
S201: acquiring a driving sequence of each pixel of a display panel, and determining a driving sequence of each backlight area of a backlight unit based on the driving sequence of each pixel of the display panel.

Where, this step has been described in detail in S101 and may not be repeated herein.
S202: acquiring image data, generating local dimming data of each backlight area according to the image data, and driving a driving unit of each backlight area based on the local dimming data of the backlight area and the driving sequence of each backlight area.

A current pixel is acquired based on the driving sequence of each pixel of the display panel, where the current pixel is a pixel currently being displayed. Image data of the current pixel is acquired, and local dimming data of a current backlight area is generated based on the image data of the current pixel, where an area where the current pixel is located corresponds to the current backlight area. The local dimming data is sent to a current driving unit, which is a driving unit corresponding to the current backlight area. The current driving unit is controlled by the local dimming data to drive the backlight area to emit light.

In some embodiments, local dimming data of the current backlight area is generated based on the image data of the current pixel. A dimming data packet for the current driving unit is generated based on the local dimming data of the current backlight area and an address of the current driving unit.

In some embodiments, since a data volume of the local dimming data is smaller than that of the image data, after generating the local dimming data of the backlight area based on the current pixel, a dimming data packet is generated based on the local dimming data of the current backlight area and an address of the driving unit corresponding to the current backlight area, and the dimming data packet is sent to the current driving unit after a preset delay time. In this way, the backlight area may emit light with a delay, so as to realize the synchronous display between the backlight unit and the display panel.

In some embodiments, after local dimming data of a backlight area corresponding to a current pixel is generated, a dimming data packet is generated based on the local dimming data, a preset delay time, and an address of a driving unit. The dimming data packet is then sent to a current driving unit. Upon receiving the dimming data packet, the current driving unit delays lighting up the backlight area based on the preset delay time, thereby enabling the synchronous display between the backlight unit and the display panel.

In the above technical solutions, after the local dimming data is generated based on the image data, by the dimming data packet being delayed in sending or a preset delay time being set in the dimming data packet, the driving unit may be controlled to delay lighting up the backlight area, thereby achieving the synchronous display between the backlight unit and the display panel.

Some embodiments of the present application provide a backlight unit control method, which is applied to a controller. The backlight unit control method specifically includes the following steps.
S301: acquiring a driving sequence of each pixel of a display panel, and determining a driving sequence of each backlight area of a backlight unit based on the driving sequence of each pixel of the display panel.

Where, a driving sequence of each pixel of the display panel is driving in a unit of each row of pixels, and a driving sequence of each backlight area of the backlight unit is driving in a unit of each row of backlight areas.
S302: acquiring image data, generating local dimming data of each backlight area based on the image data, and driving a driving unit of each backlight area based on the local dimming data of the backlight area and in accordance with the driving sequence of each backlight area.

Where, at least one current row of pixels is acquired, local dimming data of a current backlight area is generated based on the image data of the at least one current row of pixels, and an area where the at least one current row of pixels is located corresponds to the current backlight area. A dimming data packet for the current driving unit is generated based on the local dimming data of the current backlight area and an address of the current driving unit. The current driving unit is the driving unit corresponding to the current backlight area.

In some embodiments, a plurality of data lines are arranged on the backlight unit, and a plurality of driving units share the same data line. A data line corresponding to the current driving unit is acquired, and the controller combines the dimming data packets of the current driving unit on the same data line and outputs them through the data line, such that the combined data packets are transmitted by the data line.

The following description takes any driving unit on the data line as an example. For ease of description, any driving unit is referred to as a target driving unit. The target driving unit receives the combined data packet that is sent by the previous driving unit, and traverses each dimming data packet in the combined data packet. For any dimming data packet in the combined data packet, for ease of description, any dimming data packet is referred to as a target dimming data packet. When the address in the target dimming data packet is the same as the address of the target driving unit, it is determined that the target dimming data packet matches the target driving unit, and the target driving unit drives the backlight unit based on the target dimming data.

Three structures of the backlight unit are taken as examples below to illustrate the transmission process of the dimming data packet. The structure of the backlight unit may also be other cases, which is not limited herein.

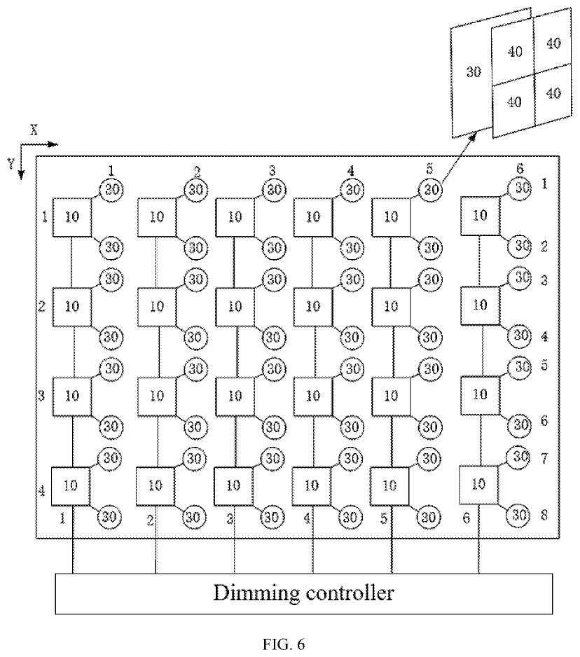

FIG. 6 is a schematic structural diagram of a backlight unit 100. A plurality of driving units 10 are arranged at intervals along a first direction X, a plurality of driving units 10 are arranged at intervals along a second direction Y, and the driving units 10 arranged at intervals along the second direction Y are sequentially connected.

The driving units 10 arranged along the first direction X are referred to as a row of driving units 10; and the driving units 10 arranged along the second direction Y are referred to as a column of driving units 10. The first column of driving units 10 is connected to a controller through a data line, the second column of driving units 10 is connected to the controller through a data line, and so on, until the last column of driving units 10 is connected to the controller through a data line.

A data line connected to the current driving unit 10 is determined, and a dimming data packet is sent to the current driving unit 10 through the data line. The dimming data packet is sent to the corresponding column of driving units, and the dimming data packet is transmitted among this column of the driving units 10. When an address of the driving unit receiving the dimming data packet is the same as an address of the driving unit in the dimming data packet, the driving unit 10 controls the backlight area 30 to emit light based on the local dimming data of the dimming data packet.

For example, as shown in FIG. 6, one backlight area 30 corresponds to 2×2 pixels, the backlight unit is provided with 8×6 backlight areas 30 and 4×6 driving units 10. One row of driving units 10 drives two rows of backlight areas 30, and one column of driving units 10 drives one column of backlight areas 30.

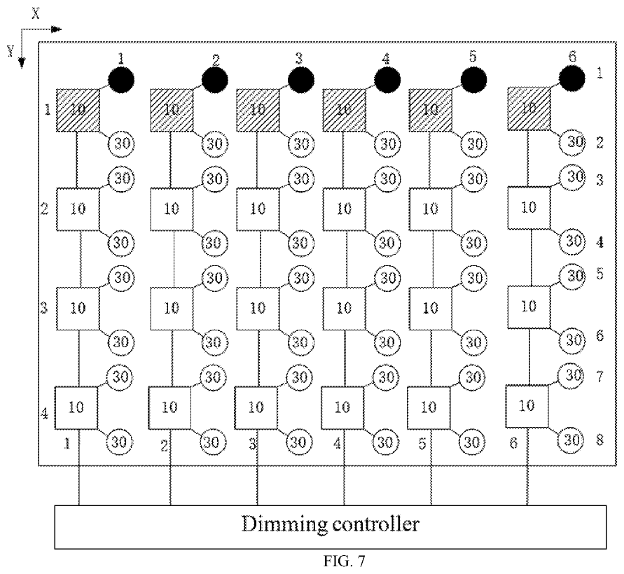

As an example, in one frame of image, the number of pixel row driven each time is the same, and one row of pixels is displayed each time. That is, in one frame of image, the first row of pixels is displayed first, then the second row of pixels is displayed, and so on. A current pixel refers to the first row of pixels, and a current backlight area 30 refers to the first row of backlight areas 30. A current driving unit 10 refers to the first row of driving units. As shown in FIG. 7, a current backlight area is indicated by black filling, and a current driving unit is indicated by diagonal filling.

A local dimming data packet for the first row of backlight areas is generated based on the image data of the first row of pixels. Specifically, the local dimming data packet for the first row of backlight areas includes local dimming data of a backlight area in the first row and first column, local dimming data of the backlight area in the first row and second column, . . . , local dimming data of the backlight area in the first row and sixth column.

The backlight area in the first row and first column is controlled by a driving unit in the first row and first column, the backlight area in the first row and second column is controlled by a driving unit in the first row and second column, . . . , the backlight area in the first row and sixth column is controlled by a driving unit in the first row and sixth column. That is, the current driving unit includes the driving unit in the first row and first column, the driving unit in the first row and second column, . . . , the driving unit in the first row and sixth column.

The driving unit in the first row and first column receives the local dimming data through a first data line, the driving unit in the first row and second column receives the local dimming data through a second data line, . . . , the driving unit in the first row and sixth column receives the local dimming data through a sixth data line.

If the current driving units do not use the same data line, there is no need to combine the dimming data packets. The local dimming data packet of the backlight area in the first row and first column is transmitted through the first data line, the local dimming data packet of the backlight area in the first row and second column is transmitted through the second data line, . . . , the local dimming data packet of the backlight area in the first row and sixth column is transmitted through the sixth data line.

After the last driving unit 10 in the first column of driving units 10 receives the dimming data packet transmitted by the first data line, the last driving unit 10 extracts the address of the driving unit from the dimming data packet. If the address of the driving unit is not the address of the last driving unit 10, the dimming data packet is transmitted to the penultimate driving unit 10. And so on, until the dimming data packet is transmitted to the first driving unit 10. After the first driving unit 10 determines that the address of the driving unit is the address of the first driving unit, the first driving unit 10 controls the backlight area 30 in the first column and first row based on the local dimming data in the dimming data packet. The transmission and processing processes of the dimming data packets from the second column of driving units 10 to the sixth column of driving units are similar, which is not repeated herein.

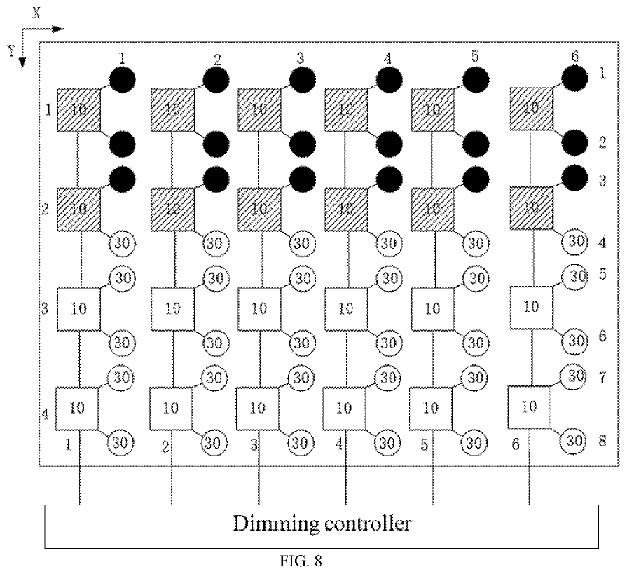

As another example, as shown in FIG. 8, in one frame of image, the number of pixel row driven each time is the same, and six rows of pixels are displayed each time. That is, in one frame of image, the first to sixth rows of pixels are displayed first, then the seventh to twelfth rows of pixels are displayed, and so on.

A current pixel refers to the first to sixth rows of pixels, and a current backlight area 30 refers to the first to third rows of backlight areas 30. A current driving unit includes the first row of driving units 10 and the second row of driving units 10.

The first row of backlight areas 30 and the second row of backlight areas 30 are driven by the first row of driving units 10. The local dimming data corresponding to the driving unit in the first row and first column includes a local dimming data packet of the backlight area in the first row and first column and local dimming data of the backlight area in the second row and first column. The local dimming data corresponding to the driving unit in the first row and second column includes a local dimming data packet of the backlight area in the first row and second column and local dimming data of the backlight area in the second row and second column . . . , the local dimming data corresponding to the driving unit in the first row and sixth column includes a local dimming data packet of the backlight area in the first row and sixth column and local dimming data of the backlight area in the second row and sixth column.

The third row of backlight areas 30 is driven by the second row of driving units 10. The local dimming data corresponding to the driving unit in the second row and first column includes a local dimming data packet of the backlight area in the third row and first column. The local dimming data corresponding to the driving unit in the second row and second column includes a local dimming data packet of the backlight area in the third row and second column . . . , the local dimming data corresponding to the driving unit in the second row and sixth column includes a local dimming data packet of the backlight area in the third row and sixth column.

The current driving unit includes the driving unit in the first row and first column, the driving unit in the first row and second column, . . . , the driving unit in the first row and sixth column. The current driving unit further includes the driving unit in the second row and first column, the driving unit in the second row and second column, . . . , the driving unit in the second row and sixth column.

The driving unit in the first row and first column and the driving unit in the second row and first column share the first data line. The driving unit in the first row and second column and the driving unit in the second row and second column share the second data line . . . , the driving unit in the first row and sixth column and the driving unit in the second row and sixth column share the sixth data line.

The local dimming data corresponding to the driving unit in the first row and first column and the local dimming data corresponding to the driving unit in the second row and first column are combined and sent to the first data line. The local dimming data corresponding to the driving unit in the first row and second column and the local dimming data corresponding to the driving unit in the second row and second column are combined and sent to the second data line . . . , the local dimming data corresponding to the driving unit in the first row and sixth column and the local dimming data corresponding to the driving unit in the second row and sixth column are combined and sent to the sixth data line.

The processing processes of the local dimming data packets by each driving unit have been described in the above embodiments, and are not repeated herein.

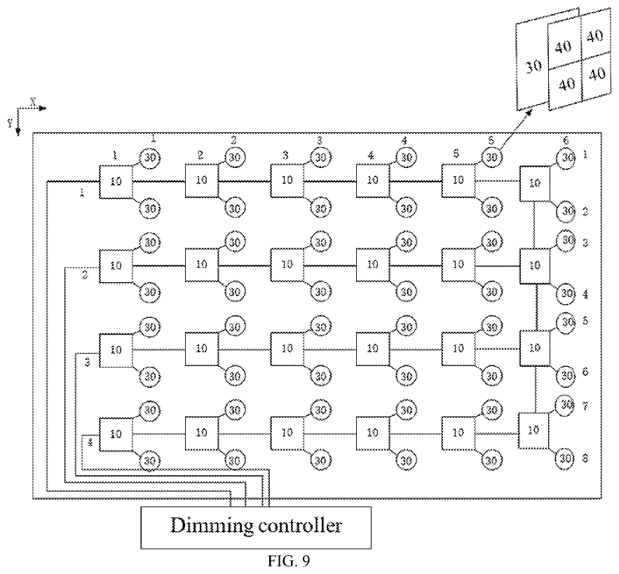

FIG. 9 is a schematic structural diagram of a backlight unit 100. A plurality of driving units 10 are arranged at intervals along a first direction X, and a plurality of driving units 10 are arranged at intervals along a second direction Y. The driving units 10 arranged along the first direction X are referred to as a row of driving units 10, and the driving units 10 arranged along the second direction Y are referred to as a column of driving units 10.

Different from the structure of the backlight unit shown in FIG. 6, the driving units 10 arranged at intervals along the first direction X are sequentially connected. The first row of driving units 10 is connected to a controller through a first data line, the second row of driving units 10 is connected to the controller through the second data line, . . . , the fourth row of driving units 10 is connected to the controller through the fourth data line.

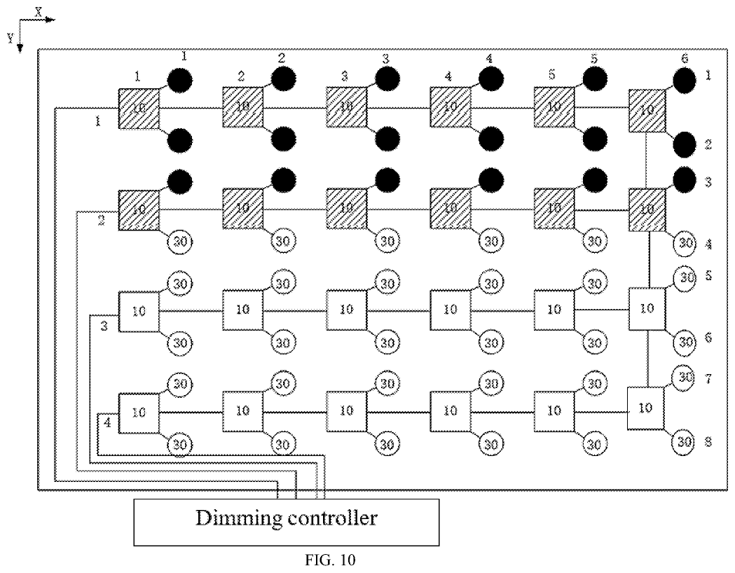

Different from FIG. 8, as shown in FIG. 10, only for the current driving unit, the driving unit in the first row and first column, the driving unit in the first row and second column, . . . , the driving unit in the first row and sixth column share the first data line; and the driving unit in the second row and first column, the driving unit in the second row and second column, . . . , the driving unit in the second row and sixth column share the second data line.

The dimming data packet corresponding to the driving unit in the first row and first column, the dimming data packet corresponding to the driving unit in the first row and second column, . . . , the dimming data packet corresponding to the driving unit in the first row and sixth column are combined and transmitted through the first data line.

The dimming data packet corresponding to the driving unit in the second row and first column, the dimming data packet corresponding to the driving unit in the second row and second column, . . . , the dimming data packet corresponding to the driving unit in the second row and sixth column are combined and transmitted through the second data line.

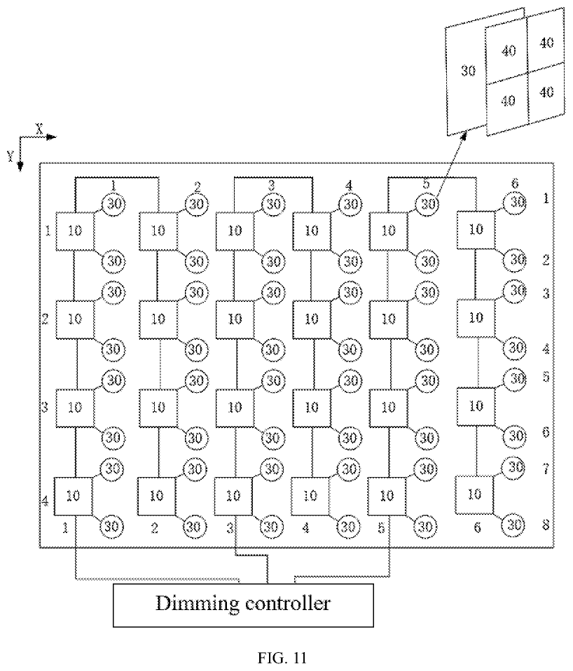

FIG. 11 is a schematic structural diagram of a backlight unit 100. A plurality of driving units 10 are arranged at intervals along a first direction X, and a plurality of driving units 10 are arranged at intervals along a second direction Y. The driving units 10 arranged along the first direction X are referred to as a row of driving units 10, and the driving units 10 arranged along the second direction Y are referred to as a column of driving units 10. Different from FIG. 6, multi-columns of driving units are divided into a plurality of groups according to positional relationship, each group of driving units includes two adjacent columns of driving units, and the two columns of driving units in each group share one data line.

FIG. 11 shows that six columns of driving units are divided into three groups. The first column of driving units and the second column of driving units share the first data line, the third column of driving units and the fourth column of driving units share the second data line, and the fifth column of driving units and the sixth column of driving units share the third data line.

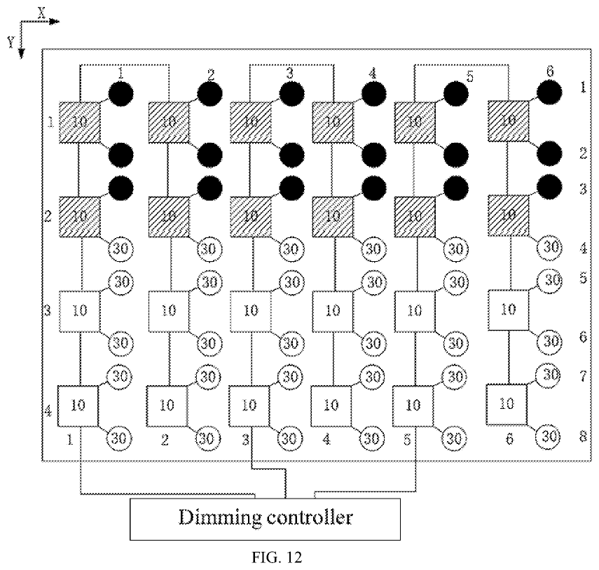

Different from FIG. 8, as shown in FIG. 12, only for the current driving unit, the driving unit in the first row and first column, the driving unit in the first row and second column, the driving unit in the second row and first column and the driving unit in the second row and second column share the first data line. The driving unit in the first row and third column, the driving unit in the first row and fourth column, the driving unit in the second row and third column and the driving unit in the second row and fourth column share the second data line. The driving unit in the first row and fifth column, the driving unit in the first row and sixth column, the driving unit in the second row and fifth column and the driving unit in the second row and sixth column share the third data line.

The dimming data packet corresponding to the driving unit in the first row and first column, the dimming data packet corresponding to the driving unit in the first row and second column, the dimming data packet corresponding to the driving unit in the second row and first column and the dimming data packet corresponding to the driving unit in the second row and second column are combined and transmitted through the first data line.

The dimming data packet corresponding to the driving unit in the first row and third column, the dimming data packet corresponding to the driving unit in the first row and fourth column, the dimming data packet corresponding to the driving unit in the second row and third column and the dimming data packet corresponding to the driving unit in the second row and fourth column are combined and transmitted through the second data line.

The dimming data packet corresponding to the driving unit in the first row and fifth column, the dimming data packet corresponding to the driving unit in the first row and sixth column, the dimming data packet corresponding to the driving unit in the second row and fifth column and the dimming data packet corresponding to the driving unit in the second row and sixth column are combined and transmitted through the third data line.

In the above technical solutions, when the display panel 200 displays in a unit of each row of pixels, local dimming data of the current backlight area 30 is generated based on the image data of the current pixel, and a dimming data packet of the current driving unit 10 is generated based on the local dimming data of the current backlight area 30 and the address of the current driving unit. In this way, a backlight source is provided in a unit of each row of backlight areas 30. That is, when the pixels of the display panel 200 are displayed simultaneously in the first direction X and sequentially in the second direction Y, the backlight areas 30 are lit simultaneously in the first direction X and sequentially in the second direction Y. In this way, the performance of the display device can be improved by synchronizing the display time of the display panel 200 and the lighting time of the backlight unit 100.

Some embodiments of the present application provide a backlight unit control device, including:
an acquisition module, configured to acquire a driving sequence of each pixel on a display panel, and determine a driving sequence of each backlight area of a backlight unit according to the driving sequence of each pixel of the display panel;
a processing module, configured to acquire image data, generate local dimming data of each backlight area based on the image data, and drive the driving unit of each backlight area based on the local dimming data of the backlight area and the driving sequence of each backlight area.

In some embodiments, the acquisition module is specifically configured to:
determine a backlight area corresponding to each pixel, and take the driving sequence of each pixel of the display panel as a driving sequence of the backlight area corresponding to each pixel.

In some embodiments, the acquisition module is specifically configured to:
determine that the driving sequence of the backlight area corresponding to each pixel is driving at least one row of backlight areas each time, when the driving sequence of each pixel of the display panel is driving at least one row of pixels each time.

In some embodiments, pixels arranged along a first direction are connected to a gate driver chip through a scan line, pixels arranged along a second direction are connected to a source driver chip through a data line, the gate driver chip is configured to send a scanning signal to at least one scan line to allow at least one row of pixels to receive the scanning signal, and the source driver chip sends data to all data lines to allow all columns of pixels to receive the data.

In some embodiments, the processing module is specifically configured to:
acquire image data of a current pixel, generate local dimming data of a current backlight area based on the image data of the current pixel, and send the local dimming data to a current driving unit;
where the current backlight area corresponds to an area where the current pixel is located, and the current driving unit is a driving unit corresponding to the current backlight area.

In some embodiments, the processing module is specifically configured to:
generate a dimming data packet of the current driving unit based on the local dimming data of the current backlight area and an address of the driving unit corresponding to the current backlight area, and send the local dimming data packet to the current driving unit.

In some embodiments, the processing module is specifically configured to:
generate the dimming data packet based on the local dimming data, a preset delay time and the address of the driving unit, and send the dimming data packet to the current driving unit to allow the current driving unit to delay lighting up the backlight area based on the preset delay time after receiving the dimming data packet.

In some embodiments, the acquisition module is specifically configured to:
wait for the preset delay time and then send the dimming data packet to the driving unit.

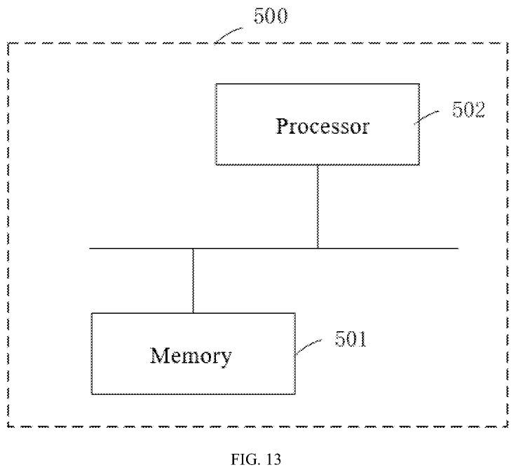

As shown in FIG. 13, an embodiment of the present application provides a controller 400, which includes a memory 401 and a processor 402.

Where, the memory 401 is configured to store computer instructions executable by the processor;
the processor 402 implements each step of the method in the foregoing embodiments when executing the computer instructions. For details, reference may be made to the relevant descriptions in the foregoing method embodiments.

In an embodiment, the above memory 401 may be independent or integrated with the processor 402. When the memory 401 is independently provided, the controller further includes a bus for connecting the memory 401 and the processor 402.

Embodiments of the present application further provide a computer-readable storage medium, in which computer instructions are stored, and when the computer instructions are executed by a processor, each step in the method in the above embodiments is implemented.

Embodiments of the present application further provide a computer program product, including computer instructions, which implement each step in the method in the above embodiments when executed by a processor.

Those skilled in the art may readily conceive of other embodiments of the present application upon consideration of the specification and practice of the application disclosed herein. The present application is intended to cover any variations, uses, or adaptations of the present application that follow the general principles of the present application and include common general knowledge or conventional technical means in the technical field not disclosed herein. The specification and embodiments are to be regarded as exemplary only, and the true scope and spirit of the present application are indicated by the appended claims.

It should be understood that the present application is not limited to the precise structures described above and shown in the accompanying drawings, and various modifications and changes may be made without departing from the scope thereof. The scope of the present application is defined only by the appended claims.

What is claimed is:

1. A backlight unit control method, comprising:
acquiring a driving sequence of each pixel of a display panel, and determining a driving sequence of each backlight area of a backlight unit according to the driving sequence of each pixel of the display panel;
acquiring image data, generating local dimming data of each backlight area based on the image data, and driving a driving unit of each backlight area based on the local dimming data of each backlight area and the driving sequence of each backlight area.

2. The control method according to claim 1, wherein determining the driving sequence of each backlight area of the backlight unit according to the driving sequence of each pixel of the display panel specifically comprises:
determining a backlight area corresponding to the each pixel, and taking the driving sequence of each pixel of the display panel as a driving sequence of the backlight area corresponding to the each pixel.

3. The control method according to claim 2, wherein taking the driving sequence of each pixel of the display panel as the driving sequence of the backlight area corresponding to the each pixel specifically comprises:
determining that the driving sequence of the backlight area corresponding to the each pixel is driving at least one row of backlight areas each time, when the driving sequence of each pixel of the display panel is driving at least one row of pixels each time.

4. The control method according to claim 3, wherein pixels arranged along a first direction are connected to a gate driver chip through a scan line, pixels arranged along a second direction are connected to a source driver chip through a data line, the gate driver chip is configured to send a scanning signal to at least one scan line to allow at least one row of pixels to receive the scanning signal, and the source driver chip sends data to all data lines to allow all columns of pixels to receive the data.

5. The control method according to claim 1, wherein acquiring image data, generating local dimming data of each backlight area based on the image data, and driving the driving unit of each backlight area based on the local dimming data of each backlight area and the driving sequence of each backlight area specifically comprises:
acquiring image data of a current pixel, generating local dimming data of a current backlight area based on the image data of the current pixel, and sending the local dimming data to a current driving unit;
wherein the current backlight area corresponds to an area where the current pixel is located, and the current driving unit is a driving unit corresponding to the current backlight area.

6. The control method according to claim 2, wherein acquiring image data, generating local dimming data of each backlight area based on the image data, and driving the driving unit of each backlight area based on the local dimming data of each backlight area and the driving sequence of each backlight area specifically comprises:
acquiring image data of a current pixel, generating local dimming data of a current backlight area based on the image data of the current pixel, and sending the local dimming data to a current driving unit;
wherein the current backlight area corresponds to an area where the current pixel is located, and the current driving unit is a driving unit corresponding to the current backlight area.

7. The control method according to claim 3, wherein acquiring image data, generating local dimming data of each backlight area based on the image data, and driving the driving unit of each backlight area based on the local dimming data of each backlight area and the driving sequence of each backlight area specifically comprises:
acquiring image data of a current pixel, generating local dimming data of a current backlight area based on the image data of the current pixel, and sending the local dimming data to a current driving unit;
wherein the current backlight area corresponds to an area where the current pixel is located, and the current driving unit is a driving unit corresponding to the current backlight area.

8. The control method according to claim 4, wherein acquiring image data, generating local dimming data of each backlight area based on the image data, and driving the driving unit of each backlight area based on the local dimming data of each backlight area and the driving sequence of each backlight area specifically comprises:
acquiring image data of a current pixel, generating local dimming data of a current backlight area based on the image data of the current pixel, and sending the local dimming data to a current driving unit;
wherein the current backlight area corresponds to an area where the current pixel is located, and the current driving unit is a driving unit corresponding to the current backlight area.

9. The control method according to claim 5, wherein sending the local dimming data to the current driving unit specifically comprises:
generating a dimming data packet of the current driving unit based on the local dimming data of the current backlight area and an address of the driving unit corresponding to the current backlight area, and sending the local dimming data packet to the current driving unit.

10. The control method according to claim 6, wherein sending the local dimming data to the current driving unit specifically comprises:
generating a dimming data packet of the current driving unit based on the local dimming data of the current backlight area and an address of the driving unit corresponding to the current backlight area, and sending the local dimming data packet to the current driving unit.

11. The control method according to claim 7, wherein sending the local dimming data to the current driving unit specifically comprises:
generating a dimming data packet of the current driving unit based on the local dimming data of the current backlight area and an address of the driving unit corresponding to the current backlight area, and sending the local dimming data packet to the current driving unit.

12. The control method according to claim 8, wherein sending the local dimming data to the current driving unit specifically comprises:
generating a dimming data packet of the current driving unit based on the local dimming data of the current backlight area and an address of the driving unit corresponding to the current backlight area, and sending the local dimming data packet to the current driving unit.

13. The control method according to claim 9, wherein generating the dimming data packet of the current driving unit based on the local dimming data of the current backlight area and the address of the driving unit corresponding to the current backlight area specifically comprises:
generating the dimming data packet based on the local dimming data, a preset delay time and the address of the driving unit, and sending the dimming data packet to the current driving unit to allow the current driving unit to delay lighting up the backlight area based on the preset delay time after receiving the dimming data packet.

14. The control method according to claim 10, wherein generating the dimming data packet of the current driving unit based on the local dimming data of the current backlight area and the address of the driving unit corresponding to the current backlight area specifically comprises:
generating the dimming data packet based on the local dimming data, a preset delay time and the address of the driving unit, and sending the dimming data packet to the current driving unit to allow the current driving unit to delay lighting up the backlight area based on the preset delay time after receiving the dimming data packet.

15. The control method according to claim 11, wherein generating the dimming data packet of the current driving unit based on the local dimming data of the current backlight area and the address of the driving unit corresponding to the current backlight area specifically comprises:
generating the dimming data packet based on the local dimming data, a preset delay time and the address of the driving unit, and sending the dimming data packet to the current driving unit to allow the current driving unit to delay lighting up the backlight area based on the preset delay time after receiving the dimming data packet.

16. The control method according to claim 12, wherein generating the dimming data packet of the current driving unit based on the local dimming data of the current backlight area and the address of the driving unit corresponding to the current backlight area specifically comprises:
generating the dimming data packet based on the local dimming data, a preset delay time and the address of the driving unit, and sending the dimming data packet to the current driving unit to allow the current driving unit to delay lighting up the backlight area based on the preset delay time after receiving the dimming data packet.

17. The control method according to claim 9, wherein sending the local dimming data packet to the current driving unit specifically comprises:
sending the dimming data packet to the driving unit after waiting for the preset delay time.

18. The control method according to claim 10, wherein sending the local dimming data packet to the current driving unit specifically comprises:
sending the dimming data packet to the driving unit after waiting for the preset delay time.

19. A controller, comprising: a processor, and a memory communicatively connected to the processor; wherein
the memory stores computer-executable instructions;
the processor executes the computer-executable instructions stored in the memory to implement the method according to claim 1.

20. A non-transitory computer-readable storage medium, wherein computer-executable instructions are stored in the computer-readable storage medium, and the computer-executable instructions, when executed by a processor, are configured to implement the method according to claim 1.
